(19) United States
(12) Patent Application Publication
(10) Pub. No.: US 2010/0016498 A1
(43) Pub. Date: Jan. 21, 2010

(54) Epoxy resin composition and cured article thereof

(76) Inventors: Masashi Kaji, Fukuoka (JP); Koichiro Ogami, Fukuoka (JP); Kazuhiko Nakahara, Fukuoka (JP)

Correspondence Address: BIRCH STEWART KOLASCH & BIRCH, PO BOX 747, FALLS CHURCH, VA, 22040-0747, US

(21) Appl. No.: 11/919,587

(22) PCT Filed: May 8, 2006
(86) PCT No.: PCT/JP2006/309231

§ 371 Date: Oct. 30, 2007

(30) Foreign Application Priority Data
May 10, 2005 (JP) 2005-137228

(51) Int. Cl. C08L 63/00

(52) U.S. Cl. 524/540; 525/523

(57) ABSTRACT

Disclosed is an epoxy resin composition that cures with high thermal conductivity and low thermal expansion and is capable of dissipating heat efficiently and displaying good dimensional stability when applied to encapsulation of semiconductor devices or to printed wiring boards. The epoxy resin composition is formulated from epoxy resins 50 wt % or more of which is a diphenyl ether type epoxy resin represented by the following general formula (1)

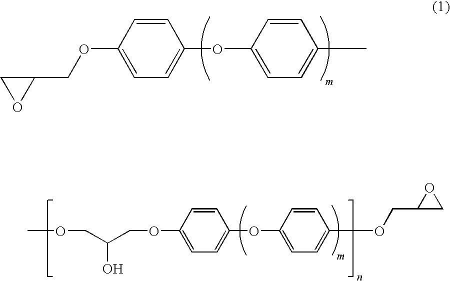

(wherein n is a number of ≧0 and m is an integer of 1-3) and curing agents 20 wt % or more of which is a diphenyl ether type phenolic resin represented by the following general formula (2)

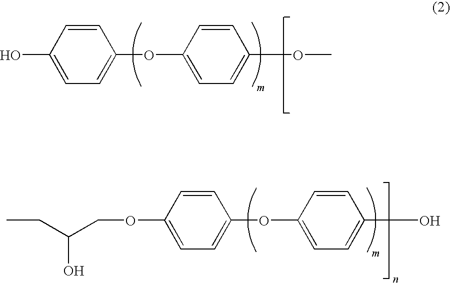

(wherein n is a number of ≧0 and m is an integer of 1-3).

### FIELD OF TECHNOLOGY

This invention relates to an epoxy resin composition which is an electrical insulator and at the same time an excellent thermal conductor and to a cured article thereof.

### BACKGROUND TECHNOLOGY

Resin compositions mainly constituted of epoxy resins are widely used for casting encapsulation, and lamination in the electrical and electronic fields. Reduction in size and weight of electronic instruments in recent years has led to high-density packaging of electronic parts. Keeping pace with this trend LSIs are advancing toward a still larger scale of integration and higher rate of operation and this has emphasized the importance of how to dissipate heat generated from electronic parts. For this reason, thermally conductive molded articles of heat-dissipating materials such as metals, ceramics, and polymeric compositions are applied to the heat-dissipating parts of printed wiring boards, semiconductor packages, box-shaped housings, heat pipes, heat-dissipating panels, heat-diffusing panels, and the like.

Of these heat-dissipating parts, cured articles obtained from epoxy resin compositions are used widely as cast articles, laminated sheets, encapsulating materials, adhesives, and the like in the electrical and electronic fields for their excellent electrical insulation properties, mechanical properties, heat resistance, chemical resistance, and adhesive properties.

The epoxy resin compositions intended for this particular application are formulated from a matrix resin and an inorganic filler such as glass, fused silica, and talc to provide a high thermal conductivity and, most generally, a high proportion of fused silica is used.

In the case where a still higher thermal conductivity is required the fillers suitable for this purpose include metal oxides such as aluminum oxide, magnesium oxide, zinc oxide, and quartz, metal nitrides such as boron nitride and aluminum nitride, metal carbides such as silicon carbide, metal hydroxides such as aluminum hydroxide, metals such as gold, silver, and copper, carbon fibers, and graphite.

The following prior-art documents are known in relation to this invention.
Patent document 1: JP2001-207031 A
Patent document 2: JP6-51778 B
Patent document 3: JP2001-172472 A
Patent document 4: JP2001-348488 A
Patent document 5: JP11-323162 A
Patent document 6: JP2004-331811 A

However, recent electronic parts generate increasingly more heat as they continue to improve in performance and function and the thermal conductivity possessed by the cured articles of conventional epoxy resin compositions is not sufficient to cope with this situation and there is a growing demand for matrix resins of higher thermal conductivity. For example, the patent documents 5 and 6 propose resin compositions formulated from liquid crystal resins having a rigid mesogenic group. However, these epoxy resins having a rigid mesogenic group such as biphenyl and azomethine show high crystallinity and high melting point and are substantially single epoxy compounds devoid of molecular weight distribution; thus, they showed poor solubility in solvents and were hard to work with in formulating compositions from them. Moreover, it was necessary to apply a strong magnetic field during curing in order to orient the molecules more efficiently in the cured state and this imposed a serious restriction on the equipment in realizing a wider commercial utilization.

The patent document 1 discloses an epoxy resin composition which is designed to reduce the load on the connecting electrode in a semiconductor device packaged by the flip chip technique by efficiently dispersing the load into a layer of encapsulating resin and to secure the conductivity of a semiconductor device under severe environmental conditions such as temperature cycle; however, the disclosure is limited to bisphenol type epoxy resins. The patent document 2 discloses an epoxy resin composition based on bisphenol type epoxy resins for use in encapsulation of semiconductors; however, no investigation is conducted into the curing agents and the object here is to lower the moisture absorption and improve the heat resistance. The patent document 3 discloses a thermally conductive epoxy resin composition containing spherical cristobalite claimed to show good flow, cause minimal wear of the molds, and cure with high thermal conductivity; however, the means resorted to here is improvement of the fillers and not improvement of the resin itself. The patent document 4 discloses an epoxy resin composition which contains a high proportion of inorganic fillers and cures with good thermal conductivity; however, the theme here is improvement of the fillers and not improvement of the resin itself.

### DISCLOSURE OF THE INVENTION

### Problems to be Solved by the Invention

An object of this invention is to provide an epoxy resin composition which is easy to work with and shows low thermal expansion and high thermal conductivity and to provide a cured article thereof.

### Means to Solve the Problems

The inventors of this invention have conducted extensive studies to solve the aforementioned problems, found a novel fact that an epoxy resin composition containing a combination of a specific epoxy resin and a specific curing agent forms a highly crystalline state even after curing and arrived at this invention.

Accordingly, this invention relates to an epoxy resin composition comprising epoxy resins and curing agents wherein a diphenyl ether type epoxy resin represented by the following general formula (1)

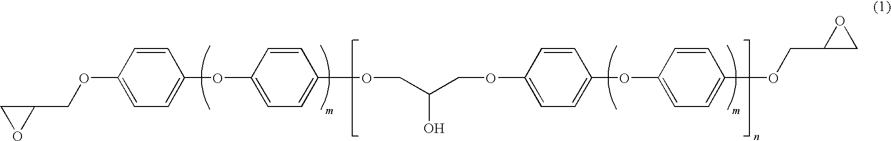

(wherein n is a number of ≧0 and m is an integer of 1-3) accounts for 50 wt % or more of the epoxy resins and a diphenyl ether type phenolic resin represented by the following general formula (2)

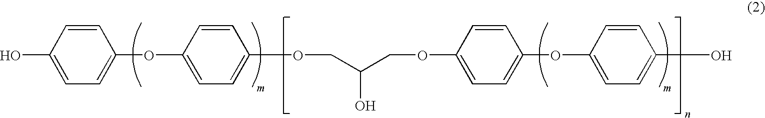

(wherein n is a number of ≧0 and m is an integer of 1-3) accounts for 20 wt % or more of the curing agents.

Incorporation of 50% or more of inorganic fillers in the epoxy resin composition of this invention can reduce further the thermal expansion and improve further the thermal conductivity. The epoxy resin composition of this invention can be cured and, desirably, the cured article has such a crystalline structure as to show an endotherm of 5 J/g or more determined by differential thermal analysis.

The epoxy resin represented by the aforementioned general formula (1) can be prepared by the reaction of a bisphenol compound represented by the following general formula (3)

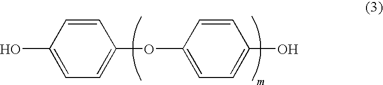

(wherein m is an integer of 1-3) with epichlorohydrin. This reaction can be carried out in the same way as the ordinary epoxidation reaction.

For example, a bisphenol compound represented by the aforementioned general formula (3) is dissolved in excess epichlorohydrin and the reaction is allowed to proceed in the presence of an alkali metal hydroxide such as sodium hydroxide and potassium hydroxide at a temperature in the range of 50-150° C., preferably in the range of 60-100° C., for a time of 1 to 10 hours. In this case, the amount of alkali metal hydroxide is in the range of 0.8-1.2 moles, preferably in the range of 0.9-1.0 mole, per 1 mole of the hydroxyl group in the bisphenol compound Epichlorohydrin is used in excess of the hydroxyl group in the bisphenol compound normally 1.5-15 moles per 1 mole of the hydroxyl group. Upon completion of the reaction, the excess epichlorohydrin is distilled off, the residue is dissolved in a solvent such as toluene and methyl isobutyl ketone, filtered washed with water to remove the inorganic salts, and stripped of the solvent to yield the object epoxy resin.

In the aforementioned general formula (1), n is a number of ≧0 and it can be adjusted easily by changing the molar ratio of epichlorohydrin to the bisphenol compound to be used in the reaction. The mean of n is preferably in the range of 1.1-3.0 from the standpoint of melting point. A number larger than this raises the melting point and the resin becomes less easy to work with.

To obtain a high-molecular-weight epoxy resin, a practicable method is a preliminary reaction of epoxy resins mainly constituted of the epoxy resin for which n=0 in general formula (1) with the bisphenol compound of general formula (3).

The bisphenol compounds useful as raw materials for the epoxy resins of this invention are represented by the aforementioned general formula (3) wherein m is 1, 2, or 3, preferably 1 or 2. Concrete examples include 4,4′-dihydroxydiphenyl ether, 1,4-b is (4-hydroxyphenoxy) benzene, and 4,4′-bis(4-hydroxyphenoxy)diphenyl ether. A mixture of these bisphenol compounds may be used as a raw material, but the one containing 50 wt % or more of 4,4′-dihydroxydiphenyl ether is preferable.

The epoxy resins for use in this invention comprise 50 wt % or more, preferably 70 wt % or more, of the epoxy resin represented by general formula (1). The epoxy equivalent of the epoxy resin represented by general formula (1) is normally in the range of 160-10,000 and it is selected suitably depending upon the intended use. For example, epoxy resins mainly constituted of the epoxy resin represented by general formula (1) wherein n=0 and have an epoxy equivalent of 400-40,000 are preferred for applications as molding materials because low viscosity is required from the standpoint of allowing the use of a high proportion of inorganic fillers and improving the flow property. Epoxy resins with an epoxy equivalent of 400-40,000 are preferably selected for applications to laminated sheets where film-forming properties and flexibility are required. This epoxy equivalent should preferably be satisfied even in the case where two or more kinds of epoxy resins are used. In such a case, the epoxy equivalent is computed by dividing the total weight of the resins in g by the number of moles of epoxy groups.

Preferably, the epoxy resin represented by general formula (1) is solid and crystalline at normal temperature, particularly in molding applications, and has a melting point of 70° C. or above and a melt viscosity of 0.005-0.5 Pa·s at 150° C. The aforementioned crystallinity, melting point, and melt viscosity should preferably be satisfied when a mixture of two or more kinds of epoxy resins is used.

The purity of an epoxy resin to be used in this invention should be adequately high and, in particular, the content of hydrolyzable chlorine should be reduced as much as possible from the standpoint of the reliability of electronic parts to which the resin is applied. Although the content of hydrolyzable chlorine is not limited to a specific level, it is preferably 1500 ppm or less, more preferably 700 ppm or less. The quantity referred to as hydrolyzable chlorine in this invention means the value determined in the following manner; 0.5 g of the sample is dissolved in 30 ml of dioxane, 10 ml of 1 N KOH is added the solution is boiled under reflux for 30 minutes and then cooled to room temperature, 100 ml of an 80% aqueous solution of acetone is added, and the resulting solution is potentiometrically titrated with an aqueous 0.002 N AgNO₃ solution.

According to this invention, it is allowable to use an ordinary epoxy resin having two or more epoxy groups in its molecule together with the essential epoxy resin represented by general formula (1). Such ordinary epoxy resins include glycidyl ethers derived from the following phenols: dihydric phenols such as bisphenol A, bisphenol F, 3,3′,5,5′-tetramethyl-4,4′-dihydroxydiphenylmethane, 4,4′-dihydroxydiphenyl sulfone, 4,4′-dihydroxydiphenyl sulfide, 4,4′-dihydroxydiphenyl ketone, fluorenebisphenol, 4,4′-biphenol, 3,3′,5,5′-tetramethyl-4,4′-dihydroxybiphenyl, 2,2′-biphenol, hydroquinone, resorcin, catechol, t-butylcatechol, t-butylhydroquinone, 1,2-dihydroxynaphthalene, 1,3-dihydroxynaphthalene, 1,4-dihydroxynaphthalene, 1,5-dihydroxynaphthalene, 1,6-dihydroxynaphthalene, 1,7-dihydroxynaphthalene, 1,8-dihydroxynaphthalene, 2,3-dihydroxynaphthalene, 2,4-dihydroxynaphthalene, 2,5-dihydroxynaphthalene, 2,6-dihydroxynaphthalene, 2,7-dihydroxynaphthalene, 2,8-dihydroxynaphthalene, allylated or polyallylated derivatives of the foregoing dihydroxynaphthalenes, allylated bisphenol A, allylated bisphenol F, and allylated phenolic novolak; trihydric or higher phenols such as phenol novolak, bisphenol A novolak, o-cresol novolak, m-cresol novolak, p-cresol novolak, xylenol novolak, poly(p-hydroxystyrene), tris(4-hydroxyphenyl)methane, 1,1,2,2-tetrakis(4-hydroxyphenyl)ethane, fluoroglycinol, pyrogallol, t-butylpyrogallol, allylated pyrogallol, polyallylated pyrogallol, 1,2,4-benzenetriol, 2,3,4-trihydroxybenzophenone, phenol aralkyl resin, naphthol aralkyl resin, and phenol dicyclopentadiene resin; and halogenated bisphenols such as tetrabromobisphenol A. These epoxy resins may be used singly or as a mixture of two kinds or more.

The epoxy resin represented by general formula (1) accounts for 50 wt % or more, preferably 70 wt % or more, of the epoxy resin composition. A composition containing the resin in an amount less than this yields a cured article with poor crystallinity and produces not much improvement in thermal conductivity.

The phenolic resins to be used in this invention contain 20 wt % or more of the diphenyl ether type phenolic resin represented by the aforementioned general formula (2). This diphenyl ether type phenolic resin normally shows a hydroxyl equivalent in the range of 100 to 5,000. An adequate value is selected for the hydroxyl equivalent depending upon the end use. For example, a phenolic resin of low viscosity is required in molding applications from the standpoint of allowing the use of a high proportion of inorganic fillers and improving the flow property. In this case, the phenolic resin represented by general formula (2) wherein predominantly n=0 is used advantageously. It is to be noted that the phenolic resin here includes a bisphenol compound or the compound for which n=0 in general formula (2) as well and from the standpoint of providing low viscosity, the content of bisphenol compounds (n=0 and m=1-3 in general formula (2)) is desirably 50 wt % or more. Concretely, such bisphenol compounds include 4,4′-dihydroxydiphenyl ether, 1,4-bis(4-hydroxyphenoxy)benzene, and 4,4′-bis(4-hydroxyphenoxy)diphenyl ether and 4,4′-dihydroxydiphenyl ether is preferable.

Application to laminated sheets requires properties such as formability into film and flexibility and a high-molecular-weight phenolic resin or the phenolic resin represented by general formula (2) wherein n≧1 is used advantageously. The hydroxyl equivalent is preferably in the range of 200-20,000.

For the synthesis of this high-molecular-weight phenolic resin (n≧1 in general formula (2)), epoxy resins mainly constituted of the epoxy resin represented by general formula (1) wherein n=0 are reacted preliminarily with an excess of the bisphenol compound represented by general formula (3).

According to this invention, an epoxy resin composition may contain generally known curing agents in addition to the essential phenolic resin represented by general formula (2). Such generally known curing agents are based on amines, acid anhydrides, phenolic compounds, polymercaptans, polyaminoamides, isocyanates, and blocked isocyanates. They are incorporated in a suitable amount in consideration of the kind of curing agent used and the properties of molded articles of thermally conductive epoxy resins.

The amine-based curing agents comprise aliphatic amines, polyetherpolyamines, alicyclic amines, and aromatic amines and concrete examples are listed below. The aliphatic amines include ethylenediamine, 1,3-diaminopropane, 1,4-diaminopropane, hexamethylenediamine, 2,5-dimethylhexamethylenediamine, trimethylhexamethylenediamine, diethylenetriamine, iminobispropylamine, bis texamethylene)triamine, triethylenetetramine, tetraethylenepentamine, pentaethylenehexamine, N-hydroxyethylethylenediamine, and tetra(hydroxyethyl)ethylenediamine. The polyetherpolyamines include triethyleneglycoldiamine, tetraethyleneglycoldiamine, diethyleneglycolbis(propylamine), polyoxypropylenediamine, and polyoxypropylenetriamine. The alicyclic amines include isophoronediamine, methanediamine, N-aminoethylpiperazine, bis(4-amino-3-methyldicyclohexyl)methane, bis(aminomethyl)cyclohexane, 3,9-bis(3-aminopropyl)-2,4,8,10-tetraoxaspiro(5,5)undecane, and norbornenediamine. The aromatic amines include tetrachloro-p-xylenediamine, m-xylenediamine, p-xylenediamine, m-phenylenediamine, o-phenylenediamine, P-phenylenediamine, 2,4-diaminoanisole, 2,4-toluenediamine, 2,4-diaminodiphenylmethane, 4,4′-diaminodiphenylmethane, 4,4′-diamino-1,2-diphenylethane, 2,4-diaminodiphenyl sulfone, 4,4′-diaminodiphenyl sulfone, m-aminophenol, m-aminobenzylamine, benzyldimethylamine, 2-(dimethylaminomethyl)phenol, triethanolamine, methylbenzylamine, α-(m-aminophenyl)ethylamine, α-(p-aminophenyl)ethylamine, diaminodiethyldimethyldiphenylmethane, and α,α′-bis(4-aminophenyl)-p-diisopropylbenzene.

Examples of the curing agents based on acid anhydrides include dodecenylsuccinic anhydride, polyadipic acid anhydride, polyazelaic acid anhydride, polysebacic acid anhydride, poly(ethyloctadecanedioic) anhydride, poly(phenylhexadecanedioic) anhydride, methyltetrahydrophthalic anhydride, methylhexahydrophthalic anhydride, hexahydrophthalic anhydride, methyl himic anhydride, tetrahydrophthalic anhydride, trialkyltetrahydrophthalic anhydride, methylcyclohexenedicarboxylic anhydride, methylcyclohexenetetracarboxylic dianhydride, phthalic anhydride, trimellitic anhydride, pyromellitic dianhydride, benzophenonetetracarboxylic dianhydride, ethylene glycol bistrimellitate, HET anhydride, nadic anhydride, nadic methyl anhydride, 5-(2,5-dioxotetrahydro-3-furanyl)-3-methyl-3-cyclohexane-1,2-dicarboxylic anhydride, 3,4-dicarboxy-1,2,3,4-tetrahydro-1-naphthalenesuccinic acid dianhydride, and 1-methyl-dicarboxy-1,2,3,4-tetrahydro-1-naphthalenesuccinic acid dianhydride.

Examples of the phenolic curing agents include bisphenol A, bisphenol F, phenol novolak, bisphenol A novolak, o-cresol novolak, m-cresol novolak, p-cresol novolak, xylenol novolak, polyp-hydroxystyrene, resorcin, catechol, t-butylcatechol, t-butylhydroquinone, fluoroglycinol, pyrogallol, t-butylpyrogallol, allylated pyrogallol, polyallylated pyrogallol, 1,2,4-benzenetriol, 2,3,4-trihydroxybenzophenone, 1,2-dihydroxynaphthalene, 1,3-dihydroxynaphthalene, 1,4-dihydroxynaphthalene, 1,5-dihydroxynaphthalene, 1,6-dihydroxynaphthalene, 1,7-dihydroxynaphthalene, 1,8-dihydroxynaphthalene, 2,3-dihydroxynaphthalene, 2,4-dihydroxynaphthalene, 2,5-dihydroxynaphthalene, 2,6-dihydroxynaphthalene, 2,7-dihydroxynaphthalene, 2,8-dihydroxynaphthalene, allylated or poyallylated derivatives of the foregoing dihydroxynaphthalenes, allylated bisphenol A, allylated bisphenol F, allylated phenol novolak, and allylated pyrogallol.

The content of the phenolic resin represented by general formula (2) in the entire curing agents incorporated in the epoxy resin composition is 20 wt % or more, preferably 40 wt % or more, more preferably 60 wt % or more. When the content of this phenolic resin is less than 20 wt %, the composition cures with a low degree of crystallinity and the thermal conductivity is not expected to improve. Moreover, when a curing agent other than the phenolic resin represented by general formula (2) is used the curing agent in question preferably has a phenolic hydroxyl group from the standpoint of heat resistance, moisture resistance, and electrical insulation.

According to this invention, a suitable amount of inorganic fillers may be incorporated in the epoxy resin composition to improve the thermal conductivity of the cured article. Such inorganic fillers are chosen from metals, metal oxides, metal nitrides, metal carbides, metal hydroxides, and carbonaceous materials. The metals include silver, copper, gold, platinum and zirconium; the metal oxides include silica, aluminum oxide, magnesium oxide, titanium oxide, and tungsten trioxide; the metal nitrides include boron nitride, aluminum nitride, and silicon nitride; the metal carbides include silicon carbide; the metal hydroxides include aluminum hydroxide and magnesium hydroxide; and the carbonaceous materials include carbon fibers, graphitized carbon fibers, natural graphite, synthetic graphite, spherical graphite particles, mesocarbon microbeads, carbon whisker, carbon microcoil, carbon nanocoil, carbon natotube, and carbon nanohorn. The inorganic fillers can be applied as pulverized or in the form of sphere, whisker, or fiber. They can be used singly or as a mixture of two kinds or more. An ordinary coupling agent may be applied to the inorganic fillers for the purposes of improving the wettability between the resin and filler, reinforcing the interface of the filler, and improving the dispersibility of the filler.

The inorganic filler is incorporated preferably at a rate of 50 wt % or more, more preferably at a rate of 70 wt % or more. A less addition produces not much improvement in the thermal conductivity.

Any known curing accelerator may be added to the epoxy resin composition of this invention. Such known curing accelerators are based on amines, imidazoles, phosphines, and Lewis acids. Concretely, the amines include tertiary amines such as 1,8-diazabicyclo(5,4,0)undecene-7, triethylenediamine, benzyldimethylamine, triethanolamine, dimethylaminoethanol, and tris(dimethylaminomethyl)phenol; the imidazoles include 2-methylimidazole, 2-phenylimidazole, 2-phenyl-4-methylimidazole, and 2-heptadecylimidazole; the phosphines include tributylphosphine, methyldiphenylphosphine, triphenylphosphine, diphenylphosphine, and phenylphosphine; the Lewis acids include tetra-substituted phosphonium tetra-substituted borates such as tetraphenylphosphonium tetraphenylborate, tetraphenylphosphonium ethyltriphenylborate, and tetrabutylphosphonium tetrabutylborate and tetraphenylborates such as 2-ethyl-4-methylimidazole tetraphenylborate and N-methylmorpholine tetraphenylborate. The addition of the curing accelerator is normally made in the range of 0.2-10 parts by weight per 100 parts by weight of epoxy resin.

Furthermore, thermoplastic oligomers may be added to the epoxy resin composition of this invention from the standpoint of improving the flow property during molding and the adhesion of the composition to the lead frame. Such thermoplastic oligomers include C5 and C9 petroleum resins, styrenic resins, indene resins, indene-styrene copolymer resins, indene-styrene-phenol copolymer resins, indene-coumarone copolymer resins, and indene-benzothiophene copolymer resins. The oligomers are added at a rate of 2-30 parts by weight per 100 parts by weight of epoxy resin.

Still further, the following additives may be added to the epoxy resin composition of this invention if necessary: fire retardants such as brominated epoxy compounds; mold release agents such as carnauba wax and ester-based waxes; coupling agents such as epoxysilanes, aminosilanes, ureidosilanes, vinylsilanes, alkylsilanes, organic titanates, and aluminum alcoholates; colorants such as carbon black; auxiliary fire retardants such as antimony trioxide; stress-reducing agents such as silicone oil; and lubricants such as higher fatty acids and metal salts thereof.

The epoxy resin composition of this invention can be obtained by thoroughly mixing the aforementioned components such as epoxy resins and curing agents at a specified ratio in a mixer, kneading the mixture in an extruder or the like, and cooling and grinding the kneaded mass.

Alternatively, the epoxy resin composition may be obtained as a varnish by dissolving the aforementioned components in a solvent such as the following: an aromatic compound such as benzene, toluene, xylene, and chlorobenzene; a ketone such as acetone, methyl ethyl ketone, methyl isobutyl ketone, and cyclohexanone: an aliphatic hydrocarbon such as hexane, butane, and methylcyclohexane; an alcohol such as ethanol, isopropanol, butanol, and ethylene glycol; an ether such as diethyl ether, dioxane, tetrahydrofuran, and diethylene glycol dimethyl ether; a polar compound such as N,N-dimethylformamide, N,N-dimethylacetamide, dimethyl sulfoxide, and N-methylpyrrolidone. Impregnation of fibrous fillers such as glass fibers, carbon fibers, and aramid fibers with this varnish followed by drying for removal of the organic solvent yields a prepreg of the epoxy resin composition.

A cured article is obtained from the epoxy resin composition of this invention by a technique such as transfer molding press molding cast molding injection molding and extrusion molding A technique such as vacuum pressing is used to cure the prepreg of the epoxy resin composition.

The cured article of this invention desirably shows crystallinity from the standpoint of securing high thermal conductivity. The degree of crystallinity can be evaluated on the basis of the amount of heat absorbed during melting determined by differential thermal analysis. The endothermic peak in differential thermal analysis is normally observed in the range of 120-250° C. and the endotherm is preferably 5 J/g or more, more preferably 10 J/g or more, most preferably 30 J/g or more, per unit weight of the resin components exclusive of the filler. An endotherm of less than 5 J/g does not produce much improvement in the thermal conductivity of the cured article. The endotherm here is the amount of heat absorbed determined by weighing the specimen accurately to 10 mg or so and testing it in a stream of nitrogen at a rate of temperature rise of 10 J/min in a differential thermal analyzer.

The cured article can be obtained from the epoxy resin composition by the aforementioned molding method and the molding operation is normally conducted at a temperature in the range of 80-250° C. for a period in the range of 1 minute to 20 hours. To raise the crystallinity of the cured article, the curing operation is preferably conducted at low temperatures for a prolonged period of time. The curing temperature is preferably in the range of 100-180° C., more preferably in the range of 120-160° C. while the curing time is preferably in the range of 10 minutes to 6 hours, more preferably in the range of 30 minutes to 3 hours. Postcure after completion of the molding helps to raise the crystallinity still further. Normally, the temperature for this postcure is in the range of 130-250° C. and the time is in the range of 1-20 hours. However, it is desirable to conduct the postcure at a temperature lower by 5-40° C. than the Peak endothermic temperature observed in differential thermal analysis for a time in the range of 1-24 hours.

The cured epoxy resin article of this invention can be laminated to base materials of different kind. The base materials for lamination are available in sheets and films and include metallic foils of copper, aluminum and stainless steel and polymeric materials such as polyethylene, polypropylene, polystyrene, polyacrylate, polymethacrylate, polyethylene terephthalate, polybutylene terephthalate, polyethylene naphthalate, liquid crystal polymers, polyamides, polyimides, and polytetrafluoroethylene.

The epoxy resin composition of this invention yields a cured article showing high thermal conductivity and low thermal expansion and when applied to encapsulation of semiconductor devices or to printed wiring boards, the cured article dissipates heat highly efficiently and displays excellent dimensional stability.

### BRIEF DESCRIPTION OF THE DRAWING

FIG. 1 is a chart of differential thermal analysis of an epoxy resin cured article.

### PREFERRED EMBODIMENTS OF THE INVENTION

This invention is described in more detail below with reference to the accompanying examples.

### Reference Example 1

To a solution of 1010 g of 4,4′-dihydroxydiphenyl ether in 7000 g of epichlorohydrin was added 808 g of a 48% aqueous solution of sodium hydroxide in drops at 60° C. under reduced pressure (at approximately 120 mmHg) over 4 hours. The water produced during this time was removed from the system by azeotropic distillation with epichlorohydrin and the distilled epichlorohydrin was returned to the system. The reaction was continued for another hour after completion of the dropwise addition. Thereafter, the reaction mixture was filtered to remove the salt formed washed with water, and distilled to strip off the epichlorohydrin to give 1515 g of crude epoxy resin as a light yellow liquid. The crude product showed an epoxy equivalent of 171 and a hydrolyzable chlorine content of 4500 ppm A solution of 1500 g of the epoxy resin thus obtained in 6000 ml of methyl isobutyl ketone was prepared 76.5 g of a 20% aqueous solution of sodium hydroxide was added to the solution, and the reaction was allowed to proceed at 80° C. for 2 hours. Upon completion of the reaction, the reaction mixture was filtered washed with water, and stripped of the solvent methyl isobutyl ketone under reduced pressure to give 1380 g of epoxy resin as a light yellow liquid. The epoxy resin thus obtained Epoxy resin A) showed an epoxy equivalent of 163, a hydrolyzable chlorine content of 280 μm a melting point of 78-84° C., and a viscosity of 0.0062 Pa·s at 150° C. The melting point was determined by the capillary method at a rate of temperature rise of 2° C./min.

### Reference Example 2

A mixture of 163 g of the epoxy resin synthesized in Reference Example 1 and 25.3 g of 4,4′-dihydroxydiphenyl ether was prepared by melting the two together at 150° C., 0.075 g of triphenylphosphine was added to the mixture, and the reaction was allowed to proceed in a stream of nitrogen for 2 hours. Upon completion of the reaction, the reaction mixture was allowed to cool to room temperature and the product resin in the meantime became crystalline and solidified. The resin thus obtained Epoxy resin B) showed an epoxy equivalent of 261, a melting point of 100-122° C., a softening point of 127° C., and a viscosity of 0.037 Pa·s at 150° C. The resin analyzed by GPC showed the following distribution of n in general formula (1): n=0, 42.5%; n=2, 29.2%; n=4, 17.6%; and n≧6, 10.7%. The viscosity was determined with the aid of Rheomat 115 available from Contrabas Co., Ltd and the softening point was determined by the ring and ball method in accordance with JIS K-6911. The GPC analysis was conducted as follows: apparatus, HLC-82A (available from Tosoh Corporation) equipped with three TSK-GEL2000 columns and one TSK-GEL4000 column (both available from Tosoh Corporation); solvent, tetrahydrofuran; flow rate, 1 ml/min; temperature, 38° C.; detector, RI.

### Reference Example 3

The reaction was carried out as in Reference Example 2 using 163 g of the epoxy resin synthesized in Reference Example 1 and 50.5 g of 4,4′-dihydroxydiphenyl ether. After the reaction was over, the reaction mixture was allowed to cool to room temperature and the resin in the meantime became crystalline and solidified The resin thus obtained Epoxy resin C) showed an epoxy equivalent of 482, a melting point of 145-165° C., and a softening point of 163° C. The resin was analyzed by GPC to show the following distribution of n in general formula (1): n=0, 16.7%; n=2, 22.1%; n=4, 32.1%; and n≧6, 29.1%.

### Example 1

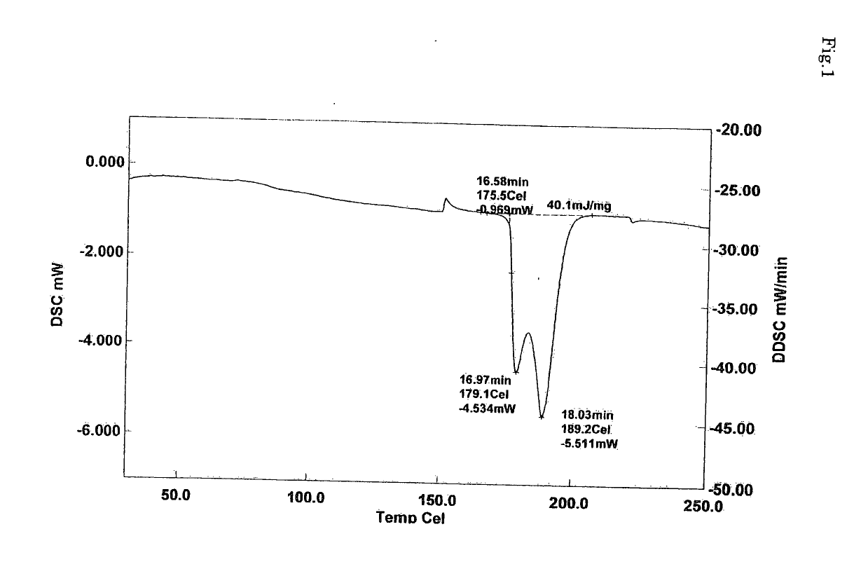

An epoxy resin composition was prepared by melting 92.5 g of the epoxy resin obtained in Reference Example 1 (Epoxy resin A), 57.3 g of 4,4′-dihydroxydiphenyl ether as a curing agent (Curing agent A), and 1.5 g of triphenylphosphine as a curing accelerator together at 120° C. A molded article of this composition was obtained by curing at 120° C. for 2 hours. The cured composition was then postcured by heating at 175° C. for 12 hours and tested for a variety of properties. The glass transition temperature and the linear expansion coefficient were determined with a thermomechanical analyzer at a rate of temperature rise of 10° C./min. The melting point and the endotherm were determined with a differential thermal analyzer at a rate of temperature rise of 10° C./min. The results are shown in FIG. 1. The thermal conductivity was determined by the nonstationary probe method using a disk 50 mm in diameter and 3 mm in thickness.

### Examples 2-5 and Comparative Examples 1-3

An epoxy resin composition was respectively prepared according to the formula shown in Table 1 by mixing one of the epoxy resins obtained in Reference Examples 1-3 (Epoxy resins A, B, and C) and a bisphenol A type epoxy resin (Epoxy resin D or YD-8125 with an epoxy equivalent of 174 available from Tohto Kasei Co., Ltd) as an epoxy resin component, 4,4′-dihydroxydiphenyl ether (Curing agent A) or phenol novolak (Curing agent B or PSM-4261 available from Gun Ei Chemical Industry Co., Ltd showing a hydroxyl equivalent of 103, a softening point of 82° C., and a melt viscosity of 0.16 Pa·s at 150° C.) as a curing agent, and triphenylphosphine as a curing accelerator. The composition was respectively cured and postcured under the conditions shown in Table 1 and the cured article was tested for the properties as in Example 1.

The results are shown together in Table 1.

TABLE 1

| | Example | | | | | Comparative example | | |
|---|---|---|---|---|---|---|---|---|
| | 1 | 2 | 3 | 4 | 5 | 1 | 2 | 3 |
| Epoxy resin A | 92.5 | 92.5 | | | 92.7 | 92.0 | | |
| Epoxy resin B | | | 108.0 | | | | | |
| Epoxy resin C | | | | 124.0 | | | | |
| Epoxy resin D | | | | | | | 95.0 | 94.5 |
| Curing agent A | 57.3 | 57.3 | 41.8 | 26.0 | 48.0 | | 55.1 | |
| Curing agent B | | | | | 9.6 | 58.1 | | 55.9 |
| Curing accelerator | 1.5 | 1.5 | 1.5 | 1.5 | 1.5 | 1.5 | 1.5 | 1.5 |
| Curing temperature (° C.) | 120 | 175 | 130 | 150 | 150 | 150 | 150 | 150 |
| Curing time (h) | 2 | 0.5 | 1 | 1 | 1 | 1 | 1 | 1 |
| Postcure temperature (° C.) | 175 | 150 | 175 | 175 | 175 | 175 | 175 | 175 |
| Postcure time (h) | 12 | 3 | 12 | 12 | 12 | 12 | 12 | 12 |
| Glass transition temperature | 94 | 92 | 105 | 119 | 123 | 126 | 118 | 124 |
| (° C.) | | | | | | | | |
| Thermal expansion coefficient | 44 | 5.6 | 4.3 | 4.2 | 5.4 | 6.4 | 6.4 | 6.6 |
| (<Tg, ×10⁻⁵) | | | | | | | | |
| Thermal expansion coefficient | 28.6 | 18.3 | 24.5 | 21.7 | 19.6 | 17.8 | 16.9 | 17.1 |
| (>Tg, ×10⁻⁵) | | | | | | | | |
| Peak endothermic temperature | 179, 189*¹⁾ | 178 | 179, 189*¹⁾ | 179, 189*¹⁾ | 178 | — | — | — |
| (° C.) | | | | | | | | |
| Endotherm (J/g) | 40.1 | 5.7 | 45.3 | 52.2 | 12.2 | 0 | 0 | 0 |
| Specific gravity (g/cc) | 1.31 | 1.27 | 1.31 | 1.34 | 1.32 | 1.24 | 1.22 | 1.20 |
| Thermal conductivity | 0.54 | 0.38 | 0.62 | 0.74 | 0.43 | 0.25 | 0.24 | 0.23 |
| (W/m · K) | | | | | | | | |

*¹⁾Two peaks were observed

What is claimed is:

1. An epoxy resin composition comprising epoxy resins and curing agents wherein a diphenyl ether type epoxy resin represented by the following general formula (1) 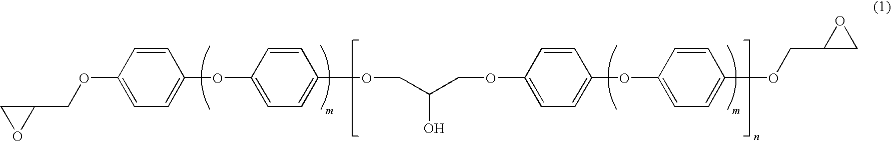
wherein n is a number of ≧0 and m is an integer of 1-3;
accounts for 50 wt % or more of the epoxy resins and a diphenyl ether type phenolic resin represented by the following general formula (2) 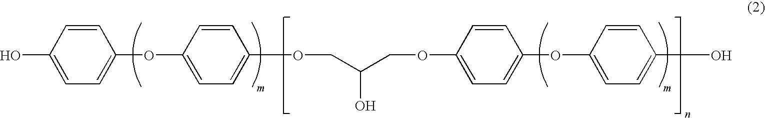
wherein n is a number of ≧0 and m is an integer of 1-3;
accounts for 20 wt % or more of the curing agents.

2. An epoxy resin composition as described in claim 1 wherein the said composition contains 50 wt % or more of inorganic fillers.

3. A cured article obtained by curing the epoxy resin composition described in claim 1 or 2.

4. A cured article of the epoxy resin composition described in claim 3 wherein the cured article has a crystal structure showing an endotherm of 5 J/g or more as determined by differential thermal analysis.
